(19) United States
(12) Patent Application Publication
(10) Pub. No.: US 2018/0110199 A1
(43) Pub. Date: Apr. 26, 2018

(54) Disposable Pet Litter Box Inserts

(71) Applicant: Wendy Venezio, Bayville, NJ (US)

(72) Inventor: Wendy Venezio, Bayville, NJ (US)

(73) Assignee: Java Pawz LLC, Bayville, NJ (US)

(21) Appl. No.: 15/790,241

(22) Filed: Oct. 23, 2017

Related U.S. Application Data
(60) Provisional application No. 62/412,607, filed on Oct. 25, 2016.

(51) Int. Cl. A01K 1/01

(52) U.S. Cl. CPC A01K 1/0125

(57) ABSTRACT

A disposable insert for a pet litter box is designed to fit inside a conventional litter box or other enclosure used for receiving wastes from pets and domestic animals. The insert comprises two nested containers, the inner of which contains the pet litter. Between the two containers is tucked a waste bag with projecting tabs that can be pulled to unfold the bag so that the bag encloses the inner container and its soiled litter and can be used to lift the insert and remove it from the litter box for disposal.

### REFERENCE TO RELATED APPLICATION

This application claims the benefit of the filing date of U.S. Provisional Patent Application No. 62/412,607, filed Oct. 25, 2016.

### FIELD OF INVENTION

The present invention relates to the field of materials used to dispose of, contain, absorb and/or deodorize pet wastes, and more particularly to pet litter boxes.

### BACKGROUND OF THE INVENTION

Perhaps the least pleasant aspect of keeping an indoor pet, such as a domestic cat, is dealing with the mess and odors associated with conventional litter boxes. Containment of litter during cleaning of a box is difficult, and pet wastes often cling to the box itself, requiring periodic washing.

The present invention addresses these problems by providing disposable pet litter box inserts, which eliminate unpleasant contact with litter and pet wastes during the box cleaning process.

### SUMMARY OF THE INVENTION

The present invention comprises a disposable insert for a pet litter box. The insert is designed to fit inside a conventional litter box, a cage or other animal enclosure used for receiving wastes from pets and/or domestic animals, or in which pet/animal wastes accumulate. The insert comprises two nested containers: an inner container, which fits snugly within an outer container. Inside the inner container is a layer of absorbent, deodorizing pet litter. Between the inner container and the outer container, an impervious waste bag, having two or more projecting bag tabs, is infolded or tucked between the contiguous inner and outer container walls, such that only the bag tabs protrude above the inner container walls.

One or more points on the waste bag are glued to the bottoms of the inner and outer containers, which can also be glued or otherwise attached together at one or more points. When the waste bag is pulled out from between the contiguous container walls, it can enclose the inner container by twisting or tying the bag tabs together. The tied-up waste bag can then be used to lift the entire insert out of the pet litter box so that soiled litter can be disposed without handing it. Upon disposal of the soiled litter, another disposable insert can then be placed into the litter box or pet/animal enclosure, and the process repeated.

Preferably, the inner and outer containers are both made of an impervious, biodegradable material such as wax-lined cardboard or vegetative pulp. Preferably, the waste bag material is a biodegradable starch/polymer blend. Optionally, the layer of cat litter within the inner container can be omitted, so that the users can insert their own litter.

The foregoing summarizes the general design features of the present invention. In the following sections, specific embodiments of the present invention will be described in some detail. These specific embodiments are intended to demonstrate the feasibility of implementing the present invention in accordance with the general design features discussed above. Therefore, the detailed descriptions of these embodiments are offered for illustrative and exemplary purposes only, and they are not intended to limit the scope either of the foregoing summary description or of the claims which follow.

### BRIEF DESCRIPTION OF THE DRAWINGS

FIG. 1A is a cutaway exploded view of a disposable insert for a pet litter box according to one embodiment of the present invention;

FIG. 1B is a cutaway view of the disposable insert of FIG. 1A in the pre-disposal configuration, with the waste bag tucked between the two contiguous containers and the bag tabs protruding above the inner container wall rims;

FIG. 1C is a cutaway view of the disposable insert of FIGS. 1A and 1B, with the waste bag unfolded from between the contiguous container and encompassing the inner container;

FIG. 2 is a top perspective view of another embodiment of the present invention, showing the protective cover over the layer of litter within the inner container;

FIG. 3 is a side perspective view of the disposable insert of FIG. 2, with the protective litter cover removed; and

FIG. 4 is a perspective view of the disposable insert of FIGS. 2 and 3 in the disposal configuration, with the fully unfolded and tied waste bag enclosing the inner container and being used to lift the disposable insert.

### DETAILED DESCRIPTION OF THE PREFERRED EMBODIMENT

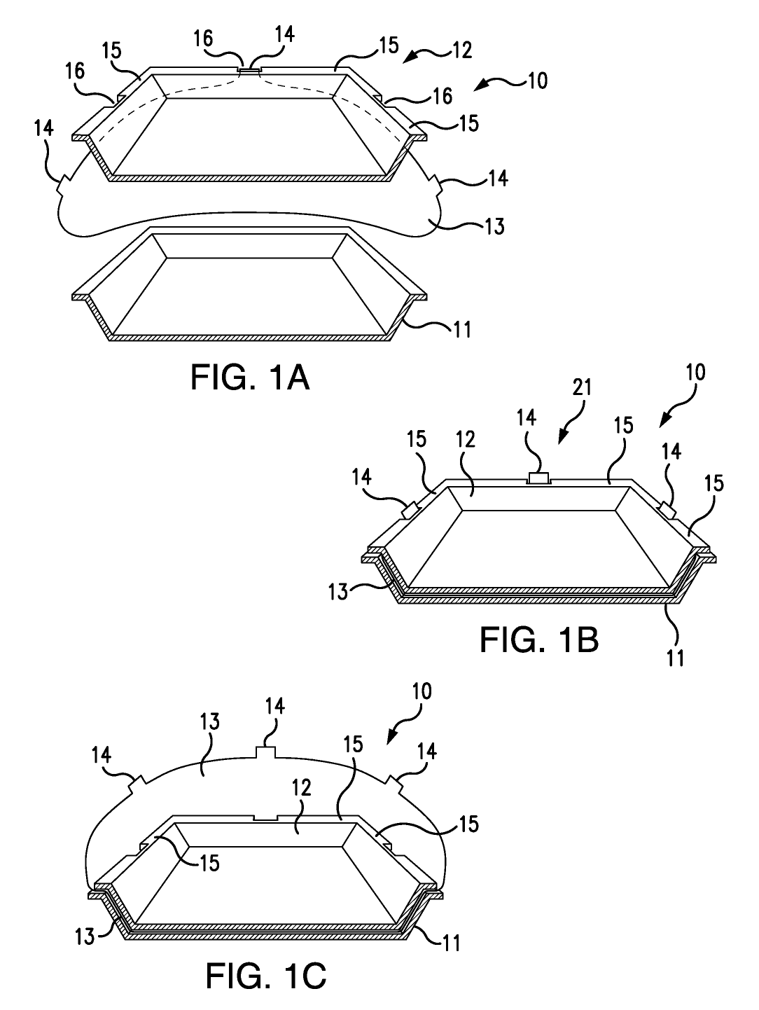

An exemplary disposable insert for a pet litter box according to one embodiment 10 of the present invention is illustrated in FIGS. 1A-1C in cut-away views, without the layer of pet litter which would cover the bottom of the inner container.

An outer container 11 is sized and shaped to fit inside an existing pet litter box. In this example, the outer container is rectangular, but it could also be oval or circular or another shape to conform to the shape of the litter box into which it would be placed. An inner container 12 is configured to slide into the outer container 11 and fit snugly within it. Tucked between the inner and outer containers 11 12 is an impervious waste bag 13, having in this example four upwardly projecting bag tabs 14 (three shown in these cutaway views), which protrude through openings 16 in the rim 15 of the inner container 12. The waste bag 13 is spot glued between the bottoms of the two containers 11 and 12, so that it can be used to lift the entire insert 10 when disposal is required. For additional support during lifting, the bottoms of the two containers 11 12 can also be spot glued.

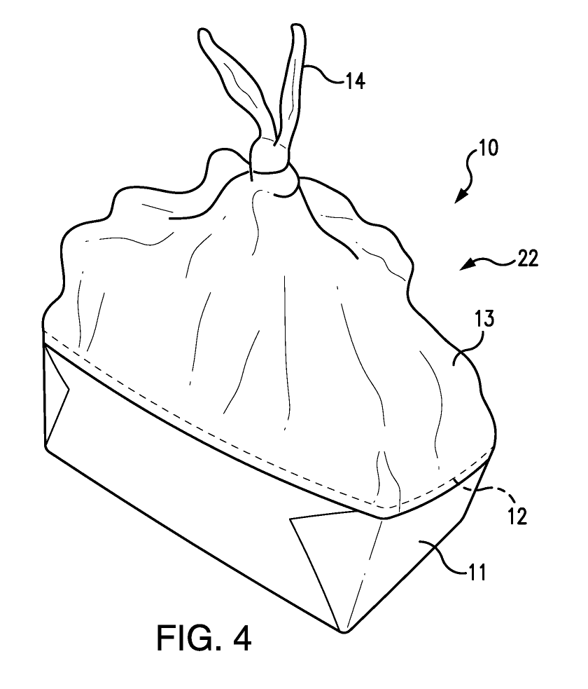

As shown in FIG. 1C, upon the bag tabs 14 being pulled out, the waste bag 13 unfolds from between the two containers 11 12 and encompasses the inner container 12. The bag tabs 14 can then be tied together, so that the litter-containing inner container 12 is fully enclosed and the insert 10 is in a disposal configuration, in which it can be lifted out of the litter box for disposal, as best seen in FIG. 4.

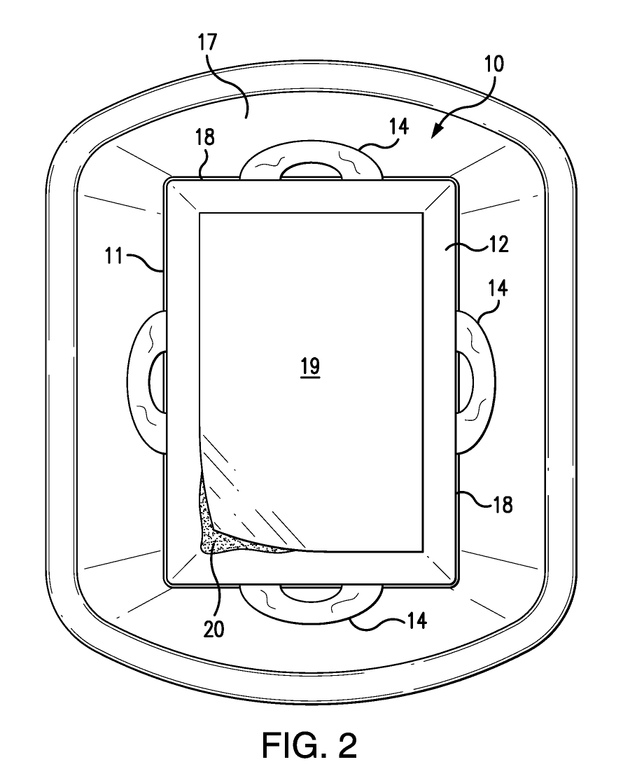

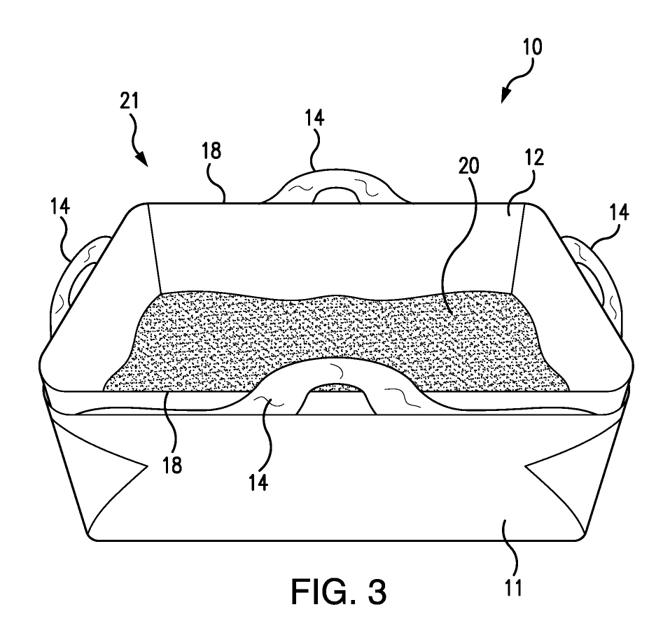

In FIG. 2, another embodiment of the insert 10 is shown inside a conventional pet litter box 17, with the bag tabs 14 protruding above the inner wall edges 18. A removable protective litter cover 19 is over the layer of absorbent, deodorizing litter 20 that covers the bottom of the inner container 12. In FIG. 3, the same embodiment of the insert 10 is depicted with the protective litter cover 19 removed, ready for use in the pre-disposal configuration 21. The same embodiment of the insert 10 is shown in FIG. 4 in the disposal configuration 22, with the waste bag 13 fully unfolded from between the two containers 11 12 and enclosing the inner container 12 and its litter 20. With the bag tabs 14 tied together, the waste bag 13 can be used to lift the entire insert 10 and remove it for disposal.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

As used in the ensuing claims, the term “pet litter box” refers broadly to any type of enclosure used to receive and temporarily hold the wastes excreted by pets or domestic animals.

What is claimed is:

1. A disposable insert for a pet litter box, comprising:
an outer container, which substantially conforms to the shape of the pet litter box and fits inside the pet litter box, wherein the outer container comprises a flat, horizontal, outer container bottom, and one or more substantially vertical outer container walls surrounding and conjoining the outer container bottom, and wherein the outer container walls upwardly terminate in outer wall edges;
an inner container, which conforms to the shape of the outer container and fits snugly within the outer container, wherein the inner container comprises a flat, horizontal, inner container bottom, and one or more substantially vertical inner container walls surrounding and conjoining the inner container bottom, and wherein the inner container walls upwardly terminate in inner wall edges;
a layer of absorbent, deodorizing pet litter located within the inner container and covering the inner container bottom, wherein the layer of pet litter is covered by a removable, protective litter cover, which can be removed to put the disposable insert into use;
a waste bag composed of a flexible, impervious material and having a bag opening around which upwardly project two or more bag tabs, wherein the waste bag has an exterior bag surface, which is adhesively attached, at one or more outer bag connection points, to an interior surface of the outer container bottom, and wherein the waste bag has an interior bag surface, which is adhesively attached, at one or more inner bag connection points, to an exterior surface of the inner container bottom, such that the waste bag is adhesively attached between the outer container and the inner container, and wherein the waste bag has a pre-disposal configuration, in which the waste bag is infolded or tucked between the outer container walls and the inner container walls, so that only the bag tabs protrude above the inner container walls, and wherein the bag tabs are configured to be pulled upward to cause the waste bag to upwardly unfold and fully encompass the inner container, thereby enabling the waste bag to assume a disposal configuration, in which the bag tabs are tied together and the waste bag fully encloses the inner container and the disposable insert can be lifted from the pet litter box for disposal.

2. The disposable insert for a pet litter box according to claim 1, wherein the outer container and the inner container are both impervious to liquids.

3. The disposable insert for a pet litter box according to claim 2, wherein the outer container, the inner container and the waste bag are composed of biodegradable materials.

4. The disposable insert for a pet litter box according to claim 3, wherein the outer wall edges and the inner wall edges have substantially horizontal rims.

5. A disposable insert for a pet litter box, comprising:
an outer container, which substantially conforms to the shape of the pet litter box and fits inside the pet litter box, wherein the outer container comprises a flat, horizontal, outer container bottom, and one or more substantially vertical outer container walls surrounding and conjoining the outer container bottom, and wherein the outer container walls upwardly terminate in outer wall edges;
an inner container, which conforms to the shape of the outer container and fits snugly within the outer container, wherein the inner container comprises a flat, horizontal, inner container bottom, and one or more substantially vertical inner container walls surrounding and conjoining the inner container bottom, and wherein the inner container bottom and the inner container walls are configured to contain a layer of absorbent, deodorizing pet litter, and wherein the inner container walls upwardly terminate in inner wall edges;
a waste bag composed of a flexible, impervious material and having a bag opening around which upwardly project two or more bag tabs, wherein the waste bag has an exterior bag surface, which is adhesively attached, at one or more outer bag connection points, to an interior surface of the outer container bottom, and wherein the waste bag has an interior bag surface, which is adhesively attached, at one or more inner bag connection points, to an exterior surface of the inner container bottom, such that the waste bag is adhesively attached between the outer container and the inner container, and wherein the waste bag has a pre-disposal configuration, in which the waste bag is infolded or tucked between the outer container walls and the inner container walls, so that only the bag tabs protrude above the inner container walls, and wherein the bag tabs are configured to be pulled upward to cause the waste bag to upwardly unfold and fully encompass the inner container, thereby enabling the waste bag to assume a disposal configuration, in which the bag tabs are tied together and the waste bag fully encloses the inner container and the disposable insert can be lifted from the pet litter box for disposal.

6. The disposable insert for a pet litter box according to claim 5, wherein the outer container and the inner container are both impervious to liquids.

7. The disposable insert for a pet litter box according to claim 6, wherein the outer container, the inner container and the waste bag are composed of biodegradable materials.

8. The disposable insert for a pet litter box according to claim 7, wherein the outer wall edges and the inner wall edges have substantially horizontal rims.
